(19) United States
(12) Patent Application Publication
(10) Pub. No.: US 2003/0140068 A1
(43) Pub. Date: Jul. 24, 2003

(54) Arrangement, system and method relating to exchange of information

(76) Inventor: Peter Yeung, Kista (SE)

Correspondence Address: ERICSSON INC., 6300 LEGACY DRIVE, M/S EVW2-C-2, PLANO, TX, 75024, US

(21) Appl. No.: 09/994,339

(22) Filed: Nov. 26, 2001

(51) Int. Cl. G06F 17/30; G06F 12/00

(52) U.S. Cl. 707/204

(57) ABSTRACT

An arrangement for handling exchange of information/messages between an information requesting side and information providing (holding) side, wherein the information requesting side comprises an information requesting application and the information providing side comprises an information providing application. Between said information requesting and information providing applications an agreement is created specifying what information should be exchangeable between the requesting and the providing applications (unidirectionally or bidirectionally). The agreement is represented through a form to be filled in by, and communicated between, the requesting and providing applications in both directions relating to requesting/setting data and/or providing data. A generic mark up language is used for implementation and communication of said form, such as XML.

### BACKGROUND

The present invention relates to an arrangement for handling exchange of information/messages between an information requesting side and an information providing (information holding) side. The information requesting side comprises an information requesting application and the information providing side comprises an information providing application. The invention also relates to a data communication system with a plurality of applications which e.g. may request information from each other, i.e. request access to information residing on other applications. Still further the invention relates to a method of exchanging information between applications.

There is no satisfactorily functioning technique known for the situation when an information requesting side requests access to information residing on an information providing side, or when an application requests information from a providing side, particularly not for queries to dynamic information. All known techniques strongly depend on the implementational structures such as used tables, of the information holding means comprised by, or associated with, an application. SQL (Structured Query Language) is one such technique which is particularly suitable when one or more pieces of information, which match a specific, given criterion, are to be searched for SQL requires input data which is highly specified, presupposing a good knowledge of the structure of databases and relations. It is not possible to dynamically, using dynamical input parameters, get the appropriate dynamical answer. Generally, when access to information is requested over an IP-based data communication network, several TCP (Transmission Control Protocol) connection setups are required. Particularly, known systems can not readily be adapted to also satisfy the needs of an end user to protect data contained in personal profiles located throughout a network, at different application or information providing sites. Particularly, there is actually no simple way for an end user to control which information should be released to whom etc. in a user friendly way. Also, more generally, there is no simple and user friendly procedure known through which dynamic information or messages can be exchanged between two applications. There is also no satisfactorily functioning solution available for inter-business communication when there is a desire not to reveal the structure etc. of used data bases.

### SUMMARY

What is needed is therefore an arrangement capable of efficiently handling exchange of information/messages between an information requesting side and an information providing or holding side. An arrangement is also needed which is easy to use and which is uncomplicated as to its functioning. An arrangement is particularly needed, which can be used for queries relating to dynamic information. An arrangement is also needed which functions independently of implementation, structure and relations of any information holding means. Most specifically an arrangement as referred to above is needed which duly can take personal privacy into consideration, i.e. which at the same time may support control of access to data within end user personal profiles.

An arrangement as initially referred to is therefore suggested, in which an agreement is given or created between an information requesting application and an information providing application, through which agreement it is specified what information should be exchangeable between the requesting and the providing applications respectively. The agreement may relate to exchange of information in one direction, or in both directions between the parties. The agreement is represented through a form to be filled in by, and communicated between, the requesting and providing applications, in both directions relating to requesting data and providing/setting data. A generic markup language is used for creation and communication of said form. In a most advantageous implementation the generic markup language is XML (Extensible Markup Language). An agreement between two parties particularly comprises a DTD (Document Type Definition) and it will in the following be referred to as a DTD agreement, i.e. an agreement specifying which data or what kind of data that is allowed to be exchanged between the two parties. The form particularly comprises an XML (node) tree tagged with information about data to be “set” or “get”, and the requested data itself, if applicable.

A DTD describes a model of the structure of the content in an XML document. The model specifies the elements which have to be provided, which elements that are optional, which their attributes are and how they could be structured in relation to each other. As a comparison, HTML (Hyper Text Markup Language) only has one DTD; by using XML, it becomes possible to create proprietary DTD:s for the user applications which provide full control of the process of controlling the content and structure of an XML document created for an application. A DTD is associated with an XML document by means of a document type declaration. A Document Type Definition, DTD, is here an XML description of the content model of the types (or classes) of the documents. A document type declaration is a submission in an XML file to explain that a certain DTD belongs to a document. Particularly the form comprises an XML (node) tree with queries for example in the form of attributes which may be given values as the form is filled in. In a particular implementation the attributes comprise one or more of “from”, “get”, “null”, “error”, “set”, the significance of which should be clear from the reading.

In one implementation the tagged XML form comprises an XML string. In an alternative implementation the tagged XML form comprises an XML object (a DOM node tree object). DOM is an abbreviation of Document Object Model as defined by W3C, World Wide Web Consortium. DOM is a standardized tree based application programming interface (API) for XML. The object form presupposes the provisioning of transforming/parsing means in the respective applications, i.e. the requesting application and the information providing application, for transforming XML objects to XML strings using an XSL transformation style sheet (XSLT) and to parse an XML string to an XML object. In particular implementations server means are associated with the requesting and providing applications respectively. An XML string is “visible” to the user, i.e. it can be read, as opposed to the XML object which is “invisible”, i.e. not readable.

According to the invention the providing application comprises means for converting a received XML form query to a database call, e.g. of SQL format, to fetch the requested information, which, when retrieved is entried/filled in on the form for retransmittal to the requesting application (if it is a pull or “get” (retrieve) operation). An application may particularly function both as a requesting and a providing application. However, for a pair of applications, an agreement may also be based on the assumption that one of the applications always acts as a requester and the other always acts as a provider, or holder.

Preferably the XML form is entirely independent of the structural implementation of any information holding/providing database or similar, as well as of any application.

In a most advantageous implementation validating means are provided for validation of a request. The validating means may comprise end user controlled, user unique DTD:s stored in information holding means. A filled-in XML form from a requesting application may be validated against the appropriate end user unique DTD to establish whether the request is allowed or not.

Particularly a “general” or basic DTD is given for the agreement, which may be used to build a basic XML form. Such a basic DTD may be applicable for exchange of information between applications relating to similar services, i.e. the same basic XML form may be used for a first application exchanging information with several second applications of the same type or category. In case validation is implemented, the DTD should be transmitted with the XML form, otherwise the inclusion of the DTD may be optional. Also for validation procedures it is however not always mandatory to include the DTD.

In a most advantageous implementation, including validation, access means (e.g. plug-in server means) are provided in, or associated with, the respective requesting and providing applications. These access means are in communication with one or more central protection server means, and together therewith they constitute a personal protection profile network. The central protection server means comprises, or communicates with, personal protection profile holding means. Particularly the personal protection profile holding means holds end user unique protection profiles specifying which data within personal profiles that should be accessible/non-accessible to which applications. The end user protection profiles are preferably end user controlled and comprise user unique DTD:s.

Particularly an application and its associated access means communicate by means of XML objects in XML transport objects, e.g. an XML node tree in an XML node tree container, e.g. using RMI (Remote Method Invocation) or CORBA™. The access means associated with a requesting application will particularly find a user unique DTD, i.e. a personal protection profile, in the central protection server means using information about the general agreement (general or basic DTD) provided from the requesting application, whereby the user unique DTD is validated against a filled-in XML form which is filled in to establish if a request should be allowed or not. Particularly HTTPS (Hyper Text Transfer Protocol Secure) is used for communication between the access means of two communicating applications and for communication between either of the applications, or rather its associated access means, and the central protection server means (also simply referred to as central server means). Internet or any other appropriate IP-based network may be used. For communication between an access means and the central protection server means the XML form has to be transported as an XML string. Also for communication between two access means the XML form has to be in the form of an XML (transport) string.

The invention also provides a data communication system providing communication between a number of applications comprising and/or communicating with service/information/content providers or holding means holding end user personal profile data. Between intercommunicating pairs of applications, an agreement is setup or given to define what information should be allowed to be transferred between the applications, either unidirectionally, i.e. from one application to the other, or bidirectionally, i.e. from the first application to the second and vice versa. Such agreements are stored in agreement information holding means. The agreements are represented in forms to be filled in and transferred between an information requesting application and an information providing application. A generic markup language is used for implementation, handling and communication of said forms. The generic markup language is particularly XML. The forms may comprise XML (node) trees tagged with information about data to be “set” or “get” (pushed or pulled) and, if applicable, (for pull requests) the requested data itself. The agreements particularly are produced in the form of DTD:s. In one implementation agreements are held by the respective applications, between which an agreement has been established, or by holding means associated with the respective applications. In an alternative implementation agreements are stored separately, or at a central location, or similar.

In one specific implementation the system also comprises a personal profile protection network (on top of e.g. an IP-based network). In a preferred implementation the personal profile protection network consists of access means associated with each respective application and central protection server means, comprising or communicating with information holding means. The information holding means may then comprise and coincide with said agreement holding means. Such a system is particularly advantageous in that it allows for, or shows one way of, enabling validation of data requests and concerned users.

Particularly attributes are used in the XML (node) tree form, which attributes may be specified or not, i.e. given a value or not, which thus constitutes the filling in of the form. The XML form tagged in such a manner (XML tree with attributes and element data), is communicated between applications as an XML string. The XML tree may in the applications (and their access means, if such are provided for) be provided in the form of XML objects, e.g. XML DOM (Document Object Model) node trees. Then, however, transforming/parsing means have to be provided in the applications (or in access means associated therewith) for transforming an XML object (DOM node tree) to an XML string to make it transportable between applications (access means, access means and central server means), and for parsing an XML string to an XML object.

In embodiments supporting validation, validating means comprise end user controlled, user unique DTD:s as personal protection profiles stored in the information holding means. An XML form tagged in the appropriate manner, from a requesting application, is validated against the appropriate user unique DTD to establish whether the request is allowed or not. Particularly, for an agreement, a general or basic DTD is given. If validation is implemented, the user unique DTD should preferably be included in the communication between requesting and providing sides, otherwise the inclusion thereof is entirely optional.

The invention also discloses a method for exchanging information/messages between an information requesting application and an information providing application having established an agreement to specify information that should be allowed to be transferred between the information requesting and information providing applications (either is one of the two applications always the requesting application and the other always the information providing application, or alternatively both applications may function as an information providing/requesting application). The method comprises the steps of; producing, using a generic markup language, a form with elements and attributes, wherein the attributes are used to indicate elements to be filled with data (according to the agreement); transferring the form as filled-in with information relating to requested data (push data or pull data) from the request application to the providing application; receiving the form at the receiving application; converting the request form to a database call; accessing the appropriate information holding site using a database call; for a request to get data (pull request): filling in the form with the data retrieved from the information holding site; returning the form as filled-in to the requesting application. (If the request relates to setting data, the appropriate data, as given in the form, is instead set at the information holding site).

The generic markup language particularly is XML, and the form comprises an XML (node) tree comprising elements with XML attributes used to indicate elements to be filled with data according to the agreement. Particularly the DTD agreement comprises a DTD which is used when producing the XML form.

The method in advantageous implementation also comprise the step of; communicating the XML form tagged with information as an XML string.

In one implementation the method comprises the step of; implementing the XML tree form as an XML DOM node tree object, then including the steps of; converting the XML DOM node tree object to an XML string in the respective requesting/providing applications for communication between said applications; parsing the XML string to a DOM node tree object in the providing application.

Alternatively the XML tree form is implemented as an XML string.

The DTD agreement may be included in the XML string. In advantageous implementations the method includes the step of; validating the XML tree against a user unique DTD stored in for example personal protection profile holding means, and requesting/providing information as allowed according to the outcome of the validation. Then the DTD agreement should preferably be included in the XML string, although not necessarily.

It is an advantage of the invention that, when a query is produced, which should be responded to, the relevant information that is needed to find the answer is generated instantly. Also the reply is generated dynamically and momentarily subsequently the information is detected.

### BRIEF DESCRIPTION OF THE DRAWINGS

The invention will in the following be further described, in a non-limiting manner, and with reference to the accompanying drawings, in which:

FIG. 1 is a first schematical illustration of two applications using an XML form for requesting and providing data,

FIG. 2 is a schematical illustration of an alternative embodiment in which an XML form is used for requesting and providing data, but wherein agreement information is stored externally,

FIG. 3 illustrates still another implementation, in which validation is performed by use of a personal profile protection network,

FIG. 4 is a flow diagram describing the flow when the XML form is implemented as a DOM node tree object;

FIG. 5 is a flow diagram describing an exemplary flow when the XML form is implemented as an XML string, and

FIG. 6 is a flow diagram describing a procedure according to one embodiment of the invention which supports a validation procedure.

### DETAILED DESCRIPTION

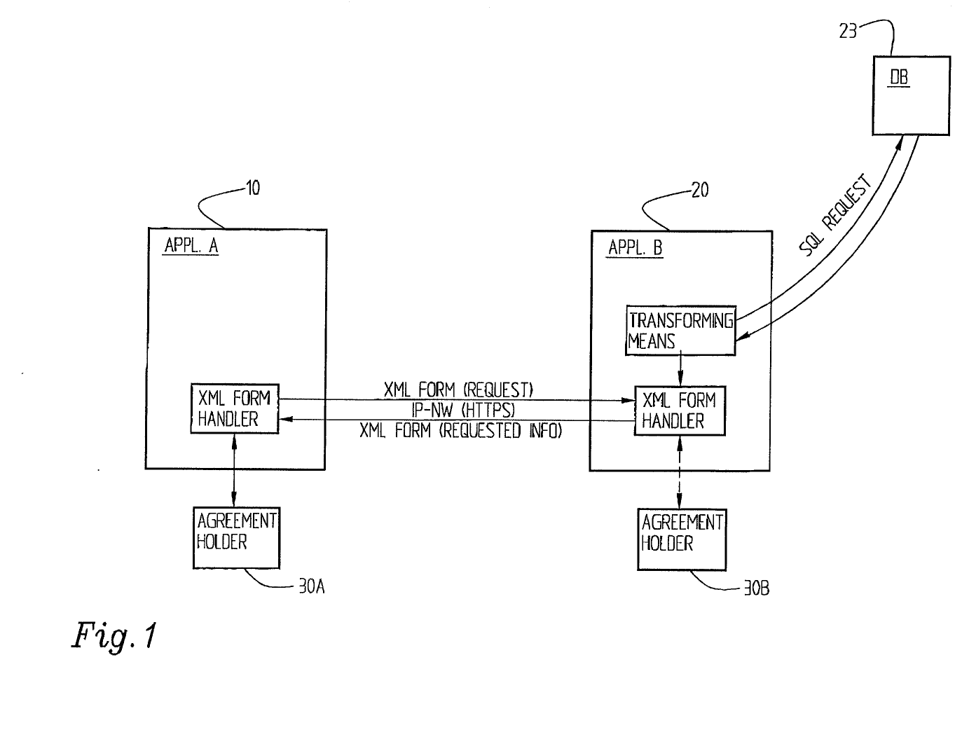

FIG. 1 very schematically illustrates two communicating applications, here denoted requesting application A 10 and information providing application B 20. It is supposed that each application 10,20 comprises or communicates with agreement holders 30A,30B for holding information about agreements established between the respective applications. It is supposed that an agreement between two applications, here applications A and B, is stored in both respective applications. The agreement holder of an application may comprise a plurality of different agreements, e.g. one for each other application with which the concerned application has concluded an agreement, and defining which, or what type of, information that is allowed to be exchanged between the respective pair of applications. In the figure it is illustrated that each respective application comprises an XML form handler, which actually comprises software (i.e. not necessarily specific means), for, using information about the agreement, creating an XML form to be filled in when a request is sent. In this first embodiment it is supposed that application A 10 requests information from application B 20.

The agreement established between applications A and B, as available in an information holder 30A, particularly in the form of a DTD (Document Type Definition) agreement, is used by the XML form handling functionality to create an XML form, e.g. in the form of an XML node tree with queries in the form of attributes to be given values in accordance with the specific request. Thus, when an XML form has been created, the attributes are given values, and the XML form tagged with information (in the attributes and element data), relating to the requested information, is transferred to application B 20 over an IP network, e.g. using HTTPS, as an XML transport file, e.g. as an XML string.

In a preferred implementation the XML node tree comprises an XML DOM node tree. Alternatively the XML tree is implemented as an XML string. If the XML form is built as an object, transformation to an XML transport string is required for purposes of transportation. The XML form received in application B 20 be will transformed to a database call, here particularly in a transforming means. Particularly it is transformed to an SQL request, to access/fetch the data as indicated by the query from a database 23 holding the requested information. When the requested information has been retrieved from database 23, the form is filled in, particularly by giving the attributes and element data the appropriate values, i.e. according to the invention as retrieved from database 23. If the request instead concerns setting of data, the “requested” data is accessed by means of e.g. SQL, and data according to the attributes is set.

The completed XML form is then returned to application A 10, and the form as filled-in may be presented to the user. However, this is merely a schematical illustration of the functioning, the main thing being that an XML form is given which comprises attributes to be given values both to define which information that is requested (for setting or getting purposes) and to contain the requested information (if relevant) when returned to requesting application. If the XML form is implemented as a string, no transformation/parsing means are required, except for the transformation (conversion) to a database call. If however the XML form is represented in the form of an XML DOM node tree, transformation means are required for purposes of transportation between the applications (and parsing means for returning the form in string format to a DOM node tree.

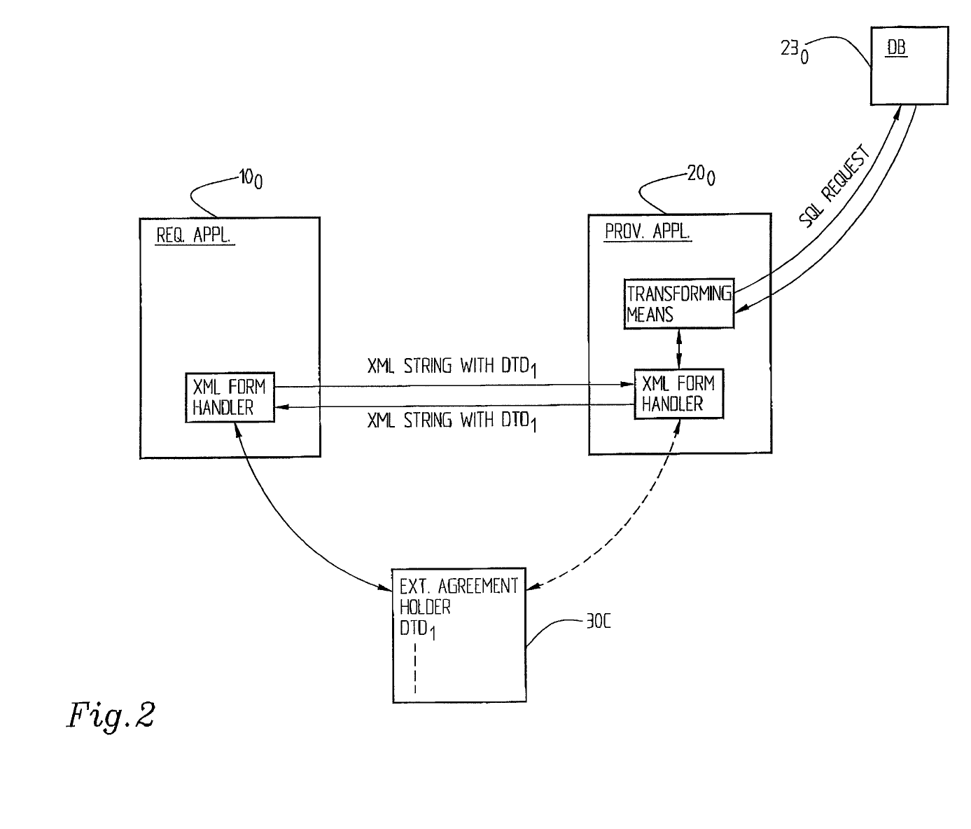

FIG. 2 schematically illustrates a somewhat different implementation in which a requesting application 10₀ requests information from a providing application 20₀, between which applications 10₀,20₀ an agreement has been established. It is here supposed that agreement information is stored in external agreement holder 30C in communication with both the requesting application 10₀ and the providing application 20₀. Communication between the agreement holder 30C and the providing application 20₀ is here indicated through a dashed line, since when requesting application 10₀ requests information from the providing application (or wants to access data on the providing/holding side), 20₀ there is no need for the providing application 20₀ to fetch the agreement (at least not when no validation is required, but also then it is not necessarily needed according to advantageous implementations). It is here supposed that agreements have been created in the form of Document Type Definitions DTD. It is supposed that the agreement between requesting application 10₀ and providing application 20₀ here is denoted DTD₁. When application 10₀ wants to get information from application 20₀, DTD₁ is fetched and an XML DOM node tree object or an XML tree string is built in XML form handler. The attributes in the XML tree are given values (assigned) relating to requested data. Examples on attributes are “from”, “get”, “set”, “null”, “error”.

In this application all embodiments are described with reference to implementations for retrieving (pulling) data from the providing side. The inventive concept is of course also applicable to the concept of pushing data, i.e. for setting data on a providing side or in an information holding site.

The XML form, if it is in form of a string, is, when the attributes have been given the appropriate values, transferred to the providing application 20₀ as an XML string, optionally including DTD₁. In the providing application 20₀, in transforming means, i.e. software which not necessarily has to be provided in a “means”, a transformation is performed to a database call, e.g. of SQL format, which call is forwarded to the database 23₀. The requested data is subsequently returned to the providing application, and filled in on the XML form as values on the concerned attributes and element data The form returned to the requesting application as an XML string (optionally with a DTD included). In one advantageous implementation the XML tree form is implemented as an XML DOM node tree object. The object has to be converted to a string for transportation from requesting application A 10 to providing application B 20. The XML string may be parsed on the providing side by means of the DOM parser to be in object form, which generally facilitates the filling-in of the form. However, for retransmittal to the requesting application, the XML DOM node tree has to be transformed to an XML node string. It is also possible to implement the XML form as an XML string without using it in object form.

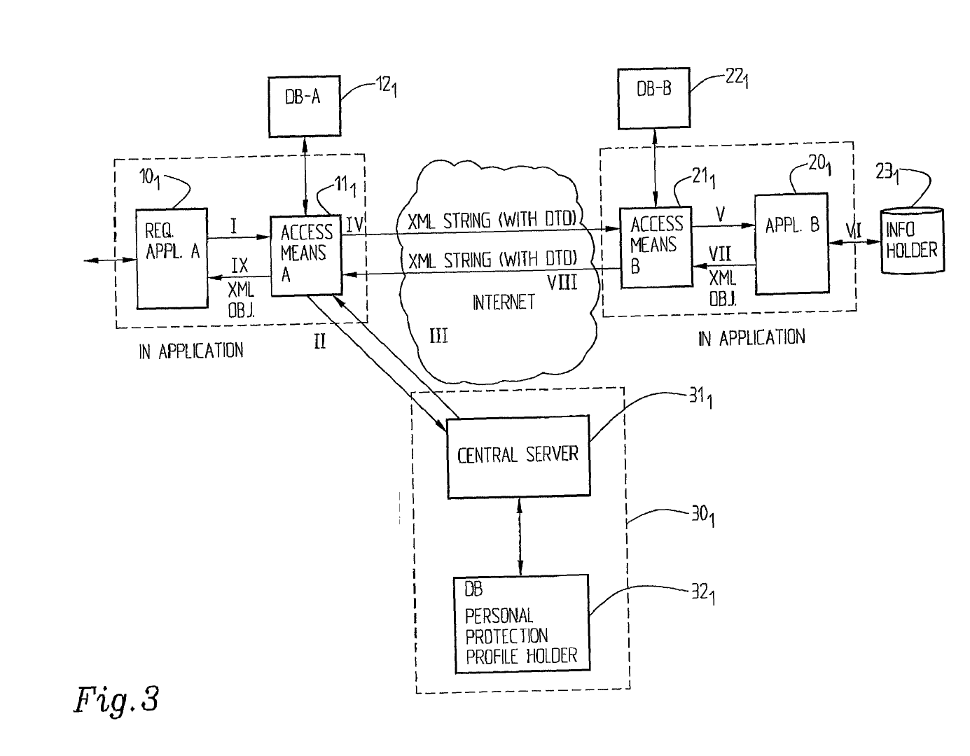

FIG. 3 describes a specific implementation including a validation procedure as described in the patent application “A SYSTEM AND A METHOD RELATING TO ACCESS CONTROL” filed in the US on Oct. 12, 2001 and the content of which herewith is incorporated herein by reference. With reference to FIG. 3 it is supposed that an information requesting application 10₁ wants to pull (get) information from an information providing application 20₁, without knowing where to find the information itself. In this implementation it is supposed that communication with the central server means is provided by the access means 11₁ interfacing the requesting application 10₁. The advantage of such an implementation is that a fast response is obtained from the privacy network, i.e. from the central server means 30₁, as to whether the requested transaction is possible, without even having to involve the access means 21₁ of the information providing application 20₁ (or the information providing application itself). The load resulting from rejected transactions on the access means 21₁ on the information providing side will be considerably reduced as compared to a case when the providing side is involved at an early stage.

Thus, when the information requesting application 10₁ wants to set information in, or get information from, an information provider, or holder, the requesting application 10₁ makes an XML request towards “its” access means 11₁. The requesting application does not know the address of the information provider. It is further supposed that access means 11₁ holds a public key and a private key. The private key PKI (Private Key Infrastructure) of a node may e.g. be stored as a key object, e.g. a secured object file.

In a particular implementation the request is sent over RMI, and it preferably contains:

the user identity (ID) associated with the request and used by the requesting application,

a DTD Agreement Version,

a DTD Agreement ID,

a Transaction ID,

an ID of the Requesting Application,

a Gateway ID, and

an XML Node Tree Container.

The XML Node Tree Container contains an XML (node) tree tagged with which information the requesting application wants to get or in which personal data he wants to set data, update data etc. The tagged XML (node) tree is described as a form, an XML DOM node tree form.

The XML Node Tree Container is an object for transportation of the XML Node Tree between the requesting application and its access means 11₁. I indicates a request from the requesting application 10₁ to the access means 11₁. Access means 11₁ finds the general DTD agreement file, a general XSLT file, the Public Key of the central server means, DNS (Domain Name Server) names and IP addresses (one or more IP number based URLs from the main central server means for the DTD agreement ID, in case there are more than one central server means).

The relevant information for central server means ID, agreement information etc. is fetched by the access means 11₁ from the associated database 12₁.

The access means 11₁ of the requesting application 10₁ then sends the request on, II, to the central server means 30₁ to find the DTD agreement. Particularly HTTPS is used, and the request particularly comprises:

the identity of the requesting application access means 11₁,

the digital signature of the requesting application access means with its private key,

the end user ID used by the requesting application 10₁,

the DTD agreement version,

the DTD agreement ID,

the Transaction ID,

the Gateway ID, and

the requesting application ID.

A response is then awaited and expected from the central server means 30₁.

The central server 31₁, which comprises control logic, checks the authentication of the request including the identity of the access means, the IP address (optionally) and the digital signature against the public key of the access means 11₁. The requesting application user ID and the DTD agreement ID are then mapped onto the information providing application user ID. It should be noted that the user identity used by a requesting application can be, or normally is, different from the user identity used by an information providing application. Further, the user identification used by an application is not the identification of the application.

The information providing application 20₁ user ID is encrypted with date/time using the public key of the access means 21₁ of the information providing application 20₁, such that it only can be read and understood by the information providing application access means 21₁. The encrypted pattern should be different every time the access means 11₁ of the requesting application 10₁ makes a request. The central server 31₁ gets a digital signature for the user unique DTD file from the database holding protection profile information 32₁, signed with the private key of the central server means 31₁. To obtain a good performance, all DTD-files are preferably signed in advance. “Out of band” information elements are also signed. (By “out of band” information is here meant the systems level communication layer, e.g. including control information for the access means. This can e.g. be implemented as HTTP POST in the forward direction and as a cookie in the backward direction.)

The central server means 31₁ then returns messages, III, to the requesting application access means 11₁ containing the user unique DTD file as in-band information. (By “in-band” is here meant information at the application data communication layer, e.g. at XML document level.) The central server means 31₁ also returns “out of band” information such as:

the digital signature of the user unique DTD file,

the digital signature of the central server means “out of band” information,

the identity of the central server means,

the encrypted user ID, i.e. the information providing application user ID,

time to live,

inactivity time,

response time,

the domain name of the access means 21₁ of the information providing application 20₁,

its IP address, and

the public keys of the respective access means 11₁, 21₁.

If the DTD agreement ID version from the central server 31₁ does not correspond to the DTD agreement ID version from the requesting application 10₁, an error notification will result and be logged. The transaction ID from the requesting application 10₁ (via its access means 11₁), the user ID of the requesting application, 10₁ and the encrypted user ID of the information providing application will be logged in the central server means 30₁.

In the access means 11₁ of the requesting application 10₁, the digital signature of the central server means 31₁, with its public key, is authenticated. The requesting access means 11₁ will perform a transformation of the XML node tree to an XML transport file (string) with the general XSLT file (the XSLT file for that particular DTD agreement ID) (XSL Transformation; XSL is e.g. described in XSL Transformations (XSLT) Version 1.0, W3C Rec. dated Nov. 10, 1999 and XSL Transformations (XSLT) Version 1.1 W3C Working draft, Dec. 12, 2000, which documents herewith are incorporated herein by reference).

The requesting application access means 11₁ validates the received user unique DTD file against the XML transport file (string). Next the XML-file will be signed. If there is a request for something, via an XML attribute, for which access is not allowed, an error message will be returned to the requesting application 10₁ by one of the access means.

If however the validation can be completed without errors, the requesting application access means 11₁ sends, to the access means 21₁ of the information providing application, IV,:

the XML transport (string) (as in-band information) and out of band information, e.g. in the form of a Cookie, i.e. the digital signature for the XML transport file (string) with the private key of the access means 11₁,

the digital signature of the out of band information from the central server means 30₁, which means the server ID,

encrypted user ID (user ID of the information providing application),

time to live,

inactivity time,

response time,

the validation of the information providing side,

DTD agreement ID and DTD agreement ID version, and

the public keys of respective access means 11₁, 21₁.

Not all digital signatures are necessary, some of them may be optional, depending on the degree of security that is demanded.

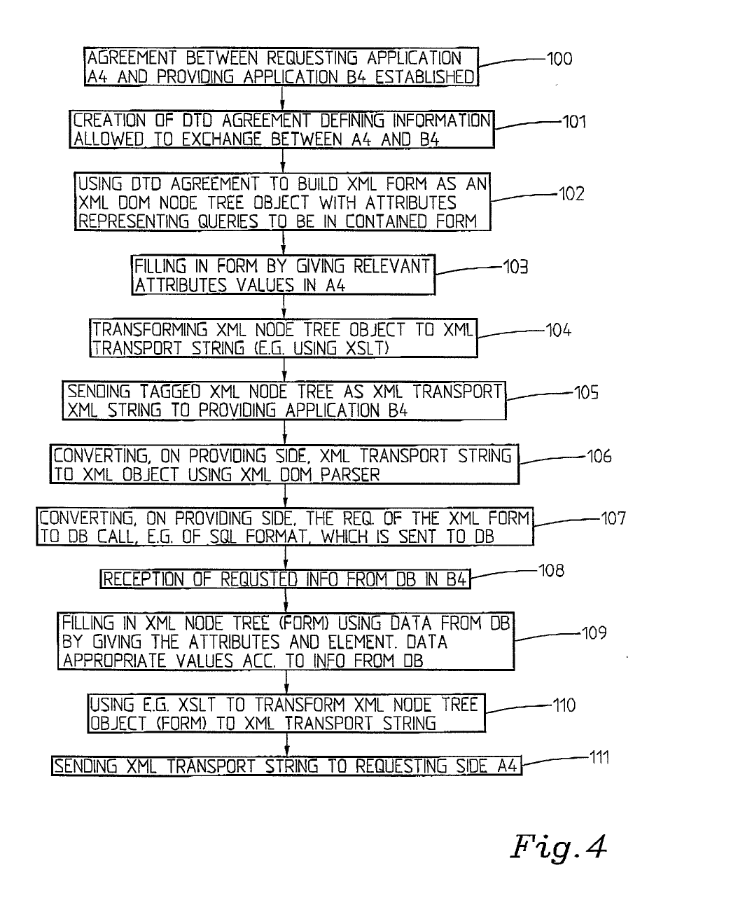

In the flow diagram of FIG. 4 is schematically illustrated how an XML form is used to request and provide data. In this implementation the object form of XML is implemented.

It is first, 100, supposed that an agreement between requesting application A4 and providing application B4 is established. (Of course an agreement may already be available, and may have been established at an earlier stage, this is not relevant for the functioning of the application, the main thing being that there is an established agreement). Using the agreement, a DTD agreement is created defining which information is allowed to exchange between A4 and B4, 101. Similar to the preceding step, a DTD agreement may already be available.

The DTD agreement is then used to build an XML form, here implemented as an XML DOM node tree object with attributes representing queries to be contained in the form, 102.

In A4 the form is then filled in by giving relevant attributes the appropriate values as will be further illustrated below, 103. Subsequently the XML DOM node tree object, i.e. the filled-in form in object form, is transformed to an XML transport string, e.g. using an XSLT, XSL style sheet, (Extensible Style Sheet Language), 104. The tagged XML node tree (i.e. tagged in that the attributes and element data are given values) is sent as an XML transport string to providing application B4, 105. On the providing side, i.e. on the side of B4, the XML transport string is parsed to an XML object using XML DOM parser, 106. On the providing side the request of the XML form is also converted to a database call, e.g. of SQL format (Structured Query Language), which is sent to the relevant database holding the information, 107. From the database, the requested information is then returned to B4, 108. The retrieved information is filled in on the XML DOM node tree (form) by giving the attributes and element data the appropriate values according to the information from the database, 109.

Subsequently the XML node tree object (form) is transformed to an XML transport string, e.g. using an XSLT as discussed above, 110. The XML transport string is returned to the requesting side comprising the requesting application A4, 111.

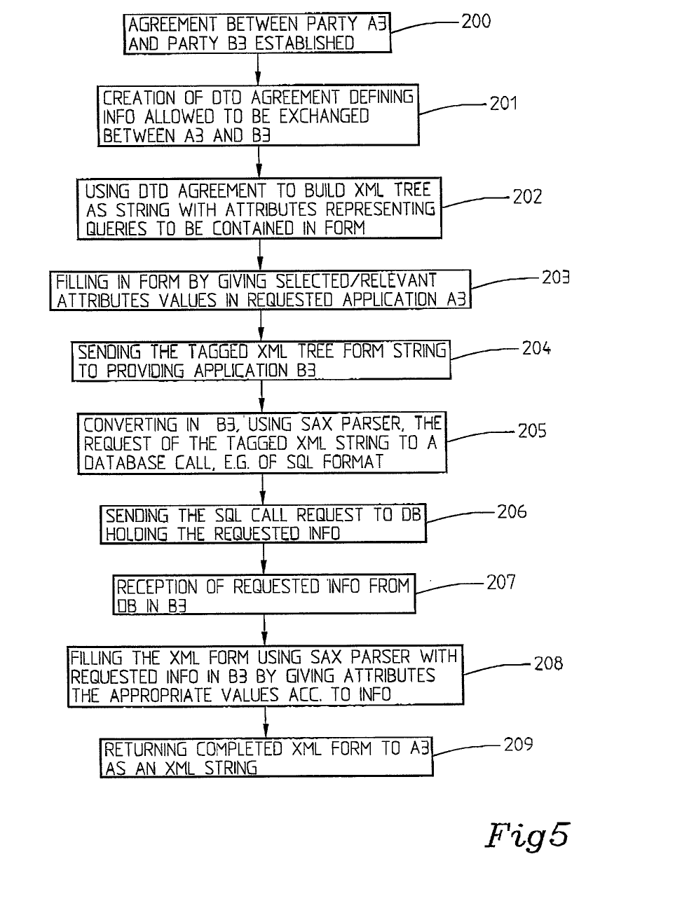

In FIG. 5 an alternative implementation is illustrated in which the XML form is implemented and transported as a string. The steps 200, 201 relating to establishment of an agreement and creation of a DTD agreement (or finding a DTD agreement) correspond to steps 100, 101 of FIG. 4, with the difference that the requesting and providing applications in this embodiment are denoted A3 and B3 respectively.

The DTD agreement is here used to implement an XML tree as a string with attributes representing queries to be contained in the form, 202. In the requesting application A3 the form is filled in by giving (assigning) values to the selected/relevant attributes (the appropriate values relating to the information to be requested), 203. The XML tree form, tagged in the described manner, is then sent (as a string) to providing application B3, 204. In B3 the request of the tagged XML string is converted to a database call, e.g. of SQL format, using a SAX parser (SAX is Simple API for XML, which is an event based Application Programming Interface as opposed to the object based API as discussed with reference to FIG. 4), 205. The SQL request is sent to the relevant database holding the requested information, 206. When the information has been retrieved, it is transferred and received in B3, 207. In B3 the XML form is filled in (using SAX parser) with the requested information by giving the attributes and element data the appropriate values according to or corresponding to the retrieved information, 208. The completed, i.e. filled in, XML form is then returned to A3 as an XML string, 209.

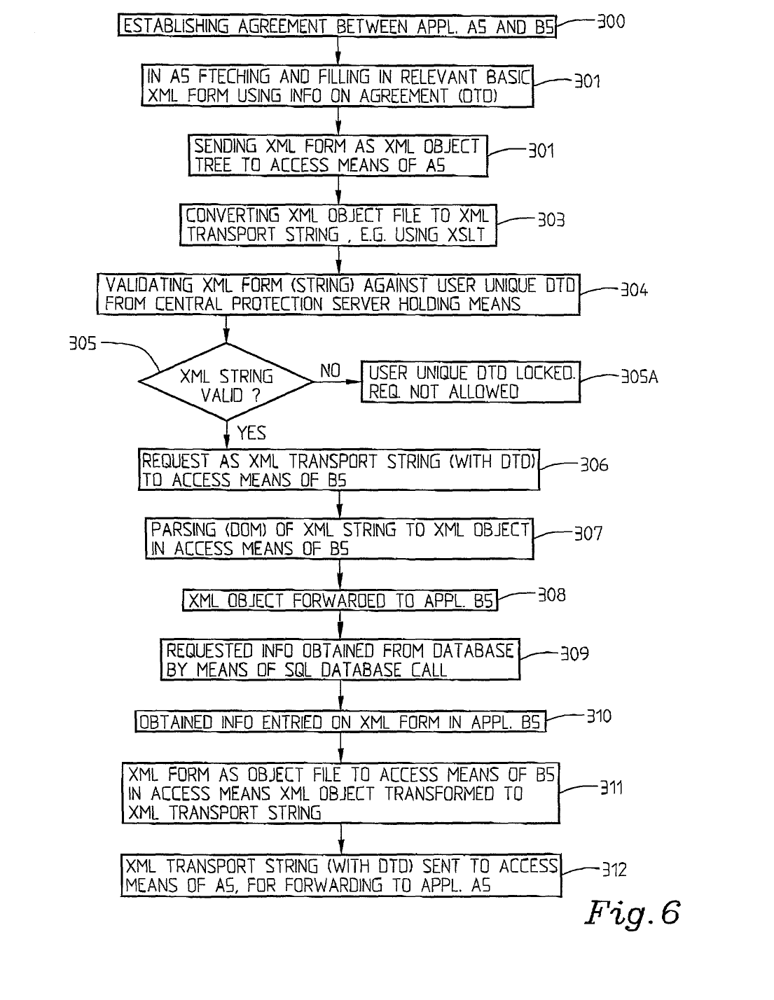

In FIG. 6 a flow diagram is illustrated which substantially corresponds to the block diagram of FIG. 3 describing an embodiment including validation by means of a privacy protection network. It is thus, like in FIGS. 4,5, supposed that there is, or has been, a step of establishing an agreement between, here, requesting application A5 and providing application B5, 300. In application A5 the relevant, basic XML form created using information on the agreement, e.g. a DTD, is, after fetching, filled in, 301. The XML form is then sent as an XML object file to the access means of A5, 302. In the access means of A5, the XML object file is converted to an XML transport string, e.g. using XSLT, 303, as also discussed above. When validation is performed, the string format has to be used. The XML form (i.e. string) is then received in the access means of A5, and validated against a user unique DTD retrieved from a relevant central protection server holding means, 304. During the validation step it is established if the XML string is valid, 305. If the XML string is not valid, this particularly means that the user unique DTD stored in the central protection server holder means is locked. Subsequently the request is not allowed, 305A. The user unique DTD stored in the central protection server holding means is particularly end user controlled, such that and end user can lock/unlock the whole DTD or partially lock/unlock the DTD.

If on the other hand it is established that the XML string is valid, the request is sent as an XML transport string (preferably with the relevant DTD, which however is an option) to the access means of B5, which like the access means of A5 may comprise a so called server plug-in, 306. In the access means of B5 parsing using DOM parser of the XML string to an XML object is performed, 307. The XML object is subsequently forwarded to application B5, 308. As described with reference to FIGS. 4,5 the requested information is obtained from a database holding the requested information by means of an SQL database call, 309, to which the request has been converted, as described above. The retrieved information is entered on the XML form in application B5, 310. The XML form is subsequently sent as an object file to the access means of B5 wherein the XML object is transformed to an XML transport string, e.g. using XSLT, 311. Thereupon the XML transport string (optionally with DTD) is sent to the access means of A5 for forwarding to application A5, 312.

For validation purposes digital signatures relating to user identities etc. may be performed in the respective access means and in the central protection server. This is however not part of the present application.

For explanatory reasons an example on an XML form with queries, in object form, may be as follows:

TestPrivacyBank.xml

<?xml version=“1.0” encoding=“ISO-8859-1” standalone=“no” ?>
<!-- General XML -->
<!-- extern DTD
<!DOCTYPE Privacy SYSTEM “TestPrivacyBank.dtd”>
-->
<Privacy>

<Bank>

<BankName BankName = “from”> Nordbanken </BankName>
<CustNumber CustNumber=“from”> 1234 </CustNumber>
<Phone Phone=“from”> 0858500000 </Phone>
<Mobile Mobile=“from”> 0702555555 </Mobile>
<Email Email=“from”> peter.xxxxx@xxx.ericsson.se </Email>
<Accounts>

<Current Current=“get”> </Current>
<LocalCurrency LocalCurrency=“get”> </LocalCurrency>
<ForeignCurrency ForeignCurrency=get”> </ForeignCurrency>
<TimeDeposit TimeDeposit=“get”> </TimeDeposit>
<Stock Stock=“get”> </Stock>
<Fund Fund=“get”> </Fund>

</Accounts>

</Bank>

</Privacy>

This XML form is not visible (readable) since it is in object form. Attributes which can be given values are “from”, “get”. The XML form in object form is sent from requesting application (A5) to its access means. Below a DTD for an XML form is shown, i.e. the basic form with an illustration of attribute selections which are possible: (This shows the basic form, after communication with the central protection server has taken place).

TestPrivacyBank.dtd

< !-- general DTD -->
< !--
attribute selections
from (input data to Application B database for pull data)
get (get data from Application B database for pull data)
null (element provides no data, don't care)
error (returned: ELEMENT contains error)
set (set the value, for push data)
-->
< !ELEMENT Privacy (Bank+) >
< !ELEMENT Bank (BankName, CustNumber, Phone?, Mobile?, Email?,
Accounts) >
< !ELEMENT BankName (#PCDATA) >
< !ATTLIST BankName BankName (from|error) #REQUIRED >
< !ELEMENT CustNumber (#PCDATA) >
< !ATTLIST CustNumber CustNumber (from|null|error) #REQUIRED >
< !ELEMENT Phone (#PCDATA) >
< !ATTLIST Phone Phone (from|null|error) #REQUIRED >
< !ELEMENT Mobile (#PCDATA) >
< !ATTLIST Mobile Mobile (from|null|error) #REQUIRED >
< !ELEMENT Email (#PCDATA) >
< !ATTLIST Email Email (from|null|error) #REQUIRED >
< !ELEMENT Accounts (Current?, LocalCurrency, ForeignCurrency?
TimeDeposit?, Stock?, Fund?) >
< !ELEMENT Current (#PCDATA) >
< !ATTLIST Current Current (get|null|error|set) #REQUIRED >
< !ELEMENT LocalCurrency (#PCDATA) >
< !ATTLIST LocalCurrency LocalCurrency (get|null|error|set)
#REQUIRED >
< !ELEMENT ForeignCurrency (#PCDATA) >
< !ATTLIST ForeignCurrency ForeignCurrency (get|null|error|set)
#REQUIRED >
< !ELEMENT TimeDeposit (#PCDATA) >
< !ATTLIST TimeDeposit TimeDeposit (get|null|error|set) #REQUIRED
< !ELEMENT Stock (#PCDATA) >
< !ATTLIST Stock Stock (get|null|error|set) #REQUIRED >
< !ELEMENT Fund (#PCDATA) >
< !ATTLIST Fund Fund (get|null|error|set) #REQUIRED >

Below is also shown an XSLT for transformation of the XML form in object format to string format (required for communication with the central protection server and for communication between applications).

TestprivacyBank.xsl

< ?xml version=“1.0” encoding=“ISO-8859-1” standalone=“yes”?>
<xsl:stylesheet xmlns:xsl=“http://www.w3.org./1999/XSL/Transform”
version=“1.0”>
<xsl:output method=“xml” indent=“yes”/>
<xsl:template match=“/Privacy“>
<Privacy>

<Bank>
<xsl:for-each select=“Bank/BankName”>

<BankName><xsl:attribute name=“BankName”><xsl:value-of

select=“@BankName”/></xsl:“attribute><xsl:value-of select=“.”/></BankName>
</xsl:for-Each>
<xsl:for-each select=“Bank/CustNumber”>

<CustNumber><xsl:attribute name=“CustNumber”><xsl:value-of

select=“@CustNumber“/></xsl; attribute><xsl:value-of select=“.”/>
</CustNumber>
</xsl:for-each>
<xsl:for-each select=“Bank/Phone”>

<Phone><xsl:attribute name=“Phone”><xsl:value-of

select=“@Phone”/></xsl:attribute><xsl:value-of select=“.”/>
</Phone>
</xsl:for-each>
<xsl:for-each select=“Bank/Mobile”>

<Mobile><xsl:attribute name=“Mobile”><xsl:value-of

select=“@Mobile”/></xsl:attribute><xsl:value-of select=“.”/>
</Mobile>
</xsl:for-each>
<xsl:for-each select=“Bank/Email”>

<Email><xsl:attribute name=“Email”><xsl:value-of

select=“@Email”/></xsl:attribute><xsl:value-of select=“.”/>
</Email>
</xsl:for-each>
<Accounts>
<xsl:for-each select=“Bank/Accounts/current”>

<Current><xsl:attribute name=“Current”><xsl:value-of

select=“@Current”/></xsl:attribute><xsl:value-of select=“.”/>
</Current>
</xsl:for-each>
<xsl:for-each select=“Bank/Accounts/LocalCurrency”>

<LocalCurrency><xsl:attribute name=“LocalCurrency”><xsl:value-

of select=“@LocalCurrency”/></xsl:attribute><xsl:value-of select=“.”/>
</LocalCurrency>
</xsl:for-each>
<xsl:for-each select=“Bank/Accounts/ForeignCurrency“>

<ForeignCurrency><xsl:attribute name=“ForeignCurrency”>

<xsl:value-of select=“@ForeignCurrency”/></xsl:attribute><xsl:
value-of select=“.”/></ForeignCurrency>
</xsl:for-each>
<xsl:for-each select=“Bank/Accounts/TimeDeposit”>

<TimeDeposit><xsl:attribute name=“TimeDeposit”><xsl:value-of

select=@TimeDeposit”/></xsl:attribute><xsl:value-of select=“.”/>
</TimeDeposit>
</xsl:for-each>
<xsl: for-each select=“Bank/Accounts/Stock”>

<Stock><xsl:attribute name=“Stock”><xsl:value-of select=

“@Stock”/></xsl:attribute><xsl:value-of select=“.”/> </Stock>
</xsl:for-each>

The DTD as described above is provided from the central protection server to the access means of the requesting application and actually results from the XSLT as described above.

The XML form in object form and the DTD will result in an XML form with queries, as can be seen below:

TestPrivacyBankTransport.xml

< ?xml version=“1.0” encoding=“ISO-8859-1” standalone=“yes”? >
< !-- XML transport file with example data -->
< !DOCTYPE Privacy
[
< !ELEMENT Privacy (Bank+) >
< !ELEMENT Bank (BankName, CustNumber, Phone?, Mobile?, Email?,
Accounts) >
< !ELEMENT BankName (#PCDATA) >
< !ATTLIST BankName BankName (from|error) #REQUIRED >
< !ELEMENT CustNumber (#PCDATA) >
< !ATTLIST CustNumber CustNumber (from|null|error) #REQUIRED >
< !ELEMENT Phone (#PCDATA) >
< !ATTLIST Phone Phone (from|null|error) #REQUIRED >
< !ELEMENT Mobile (#PCDATA) >
< !ATTLIST Mobile Mobile (from|null|error) #REQUIRED >
< !ELEMENT Email (#PCDATA) >
< !ATTLIST Email Email (from|null|error) #REQUIRED >
< !ELEMENT Accounts (Current?, LocalCurrency, ForeignCurrency?,
TimeDeposit?, Stock?, Fund?) >
< !ELEMENT Current (#PCDATA) >
< !ATTLIST Current Current (get|null|error|set) #REQUIRED >
< !ELEMENT LocalCurrency (#PCDATA) >
< !ATTLIST LocalCurrency LocalCurrency (get|null|error|set)
#REQUIRED >
< !ELEMENT ForeignCurrency (#PCDATA) >
< !ATTLIST ForeignCurrency ForeignCurrency (get|null|error|set)
#REQUIRED >
< !ELEMENT TimeDeposit (#PCDATA) >
< !ATTLIST TimeDeposit TimeDeposit (get|null|error|set) #REQUIRED >
< !ELEMENT Stock (#PCDATA) >
< !ATTLIST Stock Stock (get|null|error|set) #REQUIRED >
< !ELEMENT Fond (#PCDATA) >
< !ATTLIST Fond Fond (get|null|error|set) #REQUIRED >
]>
<Privacy>

<Bank>

<BankName BankName=“from”> Nordea </BankName>
<CustNumber CustNumber=“null”> </CustNumber>
<Phone Phone=“from”> +46858500000</Phone>
<Mobile Mobile=“null”> </Mobile>
<Email Email=“null”> </Email>
<Accounts>

<Current Current=“get”> </Current>
<LocalCurrency LocalCurrency=“get”> </LocalCurrency>
<ForeignCurrency ForeignCurrency=“null”> </ForeignCurrency>
<TimeDeposit TimeDeposit=“null”> </TimeDeposit>
<Stock Stock=“null”> </Stock>
<Fund Fund=“null”> </Fund>

</Accounts>

</Bank>

</Privacy>

The first part is the DTD, and the second is the XML form as filled-in.

This is what is sent from the access means of the requesting application to the providing application, after validation (if implemented).

As can be seen, information is wanted about current account (the attribute “get”) and also about local currency (attribute “get”). The others are “null” (except for the phone number of the requester).

Thus, above the queries and the DTD are shown. This is validated, and if the validation is successful, the above XML form (with DTD) is sent from the access means of the requesting application to the access means of the providing application, which in turn requires the requested data from a database as discussed earlier in the application. When the form has been filled in using the retrieved information, a response is returned from the access means of the providing application to the requesting application:

TestPrivacyBankTransportReturn.xml

<?xml version=“1.0” encoding=“ISO-8859-1”?>
<!-- extern DTD
<!DOCTYPE privacy SYSTEM “TestPrivacyBank.dtd”>
-->
<Privacy>
<Bank>

<BankName BankName=“from”> Nordea </BankName>

<CustNumber CustNumber=“null”> </CustNumber>
<Phone Phone=“from”> +468585000000 </Phone>
<Mobile Mobile=“null”> </Mobile>
<Email Email=“null”> </Email>
<Accounts>

<Current Current=“get”> 256 </Current>
<LocalCurrency LocalCurrency=“get”> 512 </LocalCurrency>
<TimeDeposit TimeDeposit=“null”> </TimeDeposit>
<Stock Stock=“null”> </Stock>
<Fund Fund=“null”> </Fund>

</Accounts>

</Bank>

</Privacy>

Optionally the DTD is included, this is however not illustrated.

As far as validation is concerned, below a DTD which is locked (blocked) is illustrated. Particularly this is stored in the central server means. Particularly it is used for validation of the XML object.

It can be established that there is no correspondence between the attribute values. Thus it can be concluded that the XML form query is not valid.

Blocked DTD:

TestPrivacyBankEndUserLock.dtd

<!-- End User DTD example with lock -->
<!--
selection
from (fromput data to Application B database for pull data)
get (get data from application B database, for pull data>
null (element provides no data, don't care)
error (returned: ELEMENT contains error)
set (set the value, for push data)
-->
<!ELEMENT Privacy (Bank+)>
<!ELEMENT Bank (BankName, CustNumber, Phone? Mobile? Email?,
Accounts)>
<!ELEMENT BankName (#PCDATA) >
<!ATTLIST BankName BankName (from|null|error) #REQUIRED >
<“ELEMENT CustNumber (#PCDATA) >
<!ATTLIST CustNumber CustNumber (from|null|error) #REQUIRED >
<“ELEMENT Phone (#PCDATA)>
<!ATTLIST Phone Phone (from|null|error) #REQUIRED >
<“ELEMENT Mobile (#PCDATA)>
<!ATTLIST Mobile Mobile (from|null|error) #REQUIRED >
<“ELEMENT Email (#PCDATA)>
<!ATTLIST Email Email (from|null|error) #REQUIRED >
<!ELEMENT Accounts ( Current?, LocalCurrency, ForeignCurrency?,
TimeDeposit?, Stock?, Fund?)>
<!ELEMENT Current (#PCDATA)>
<!ATTLIST Current Current (null|error) #REQUIRED >
<!ELEMENT LocalCurrency (#PCDATA)>
<!ATTLIST LocalCurrency (null|error) #REQUIRED >
<!ELEMENT ForeignCurrency (#PCDATA)>
<!ATTLIST ForeignCurrency ForeignCurrency (null|error)
#REQUIRED >
<!ELEMENT TimeDeposit (#PCDATA)>
<!ATTLIST TimeDeposit TimeDeposit (set|null|error) #REQUIRED >
<!ELEMENT Stock (#PCDATA)>
<!ATTLIST Stock Stock (null|error) #REQUIRED >
<!ELEMENT Fund (#PCDATA)>
<!ATTLIST Fund Fund (null|error) #REQUIRED > ,

and the XML file validated against the locked DTD, resulting in invalidity:

TestPrivacyBankEndUserlock.xml

<?xml version=“1.0”encoding=ISO-8859-1” standalone=“no” ?>
<!-- This is an XML demo of locked end user -->
<!-- extern DTD
<!DOCTYPE Privacy SYSTEM “TestPrivacyBankEndUserlock.dtd”>
-->
<Privacy>

<Bank>

<BankName BankName=“from”> Nordea </BankName>
<CustNumber CustNumber=“from”> </CustNumber>
<Phone Phone=“from”> </Phone>
<Mobile Mobile=“from”> +46702670652 </Mobile>
<Email Email=“from”> </Email>
<Accounts>

<Current Current=“get”> </Current>
<LocalCurrency LocalCurrency=“null”> </LocalCurrency>
<ForeignCurrency ForeignCurrency=“get”> </ForeignCurrency>
<TimeDeposit TimeDeposit=“set”> 12345 </TimeDeposit>
<Stock Stock=“get”> </Stock>
<Fund Fund=“get”> </Fond>

</Accounts>

</Bank>

</Privacy>

Correspondingly an unlocked DTD and the XML form validated against the unlocked DTD are examplified as:

TestPrivacyBankEndUserUnlock.dtd

<!-- End user DTD example with unlocked data -->
<!--
selection
from (fromput data to Application B database for pull data)
get (get data from Application B database, for pull data)
null (element provides no data, don't care)
error (returned: ELEMENT contains error)
set (set the value, for push data)
-->
<ELEMENT Privacy (Bank?)>
<!ELEMENT Bank (BankName, CustNumber, Phone?, Mobile? Email?,
Accounts)>
<!ELEMENT BankName (#PCDATA) >
<!ATTLIST BankName BankName (from|null|error) #REQUIRED >
<!ELEMENT CustNumber (#PCDATA)>
<!ATTLIST CustNumber CustNumber (from|null|error) #REQUIRED >
<!ELEMENT Phone (#PCDATA)>
<!ATTLIST Phone Phone (from|null|error) #REQUIRED >
<!ELEMENT Mobile (#PCDATA)>
<!ATTLIST Mobile Mobile (from|null|error) #REQUIRED >
<!ELEMENT Email (#PCDATA)>
<!ATTLIST Email Email (from|null|error) #REQUIRED >
<!ELEMENT Accounts ( Current?, LocalCurrency, ForeignCurrency?,
TimeDeposit?, Stock?, Fund?)>
<!ELEMENT Current (#PCDATA)>
<!ATTLIST Current Current (set|get|null|error) #REQUIRED >
<!ELEMENT LocalCurrency (#PCDATA)>
<!ATTLIST LocalCurrency LocalCurrency (set|get|null|error)
#REQUIRED >
<!ELEMENT ForeignCurrency (#PCDATA)>
<!ATTLIST ForeignCurrency ForeignCurrency (set|get|null|error)
#REQUIRED >
<!ELEMENT TimeDeposit (#PCDATA)>
<!ATTLIST TimeDeposit TimeDeposit (set|get|null|error)
#REQUIRED >
<!ELEMENT Stock (#PCDATA)>
<!ATTLIST Stock Stock (set|get|null|error) #REQUIRED >
<!ELEMENT Fund (#PCDATA)>
<!ATTLIST Fund Fund (set|get|null|error) #REQUIRED >

TestPrivacyBankEndUserUnlock.xml

<?xml version=“1.0” encoding=“ISO-8859-1” standalone=“no” ?>
<!-- This is an XML demo of unlocked end user -->
<!-- extern DTD
<!DOCTYPE Privacy SYSTEM “TestPrivacyBankEndUserUnlock.dtd”>
-->
<Privacy>

<Bank>

<BankName BankName =“from”> NORDEA </BankName>
<CustNumber CustNumber=“from”> 12345 </CustNumber>
<Phone Phone =“null”> </Phone>
<Mobile Mobile=“null”> </Mobile>
<Email Email=“from”> eraxxxx@eip.ericsson.se </Email>
<Accounts>

<Current Current=“get”> </Current>
<LocalCurrency LocalCurrency=“get”> </LocalCurrency>
<ForeignCurrency ForeignCurrency=“set”> 1234

</ForeignCurrency>

<TimeDeposit TimeDeposit=“set”> 1234 </TimeDeposit>
<Stock Stock=“null”> </Stock>
<Fund Fund=“null”> </Fund>

</Accounts>

</Bank>

</Privacy>

It should be clear that, of course the invention is not limited to the specifically illustrated embodiments, but that it can be varied in a number of ways within the scope of the appended claims.

What is claimed is:

1. An arrangement for handling an exchange of information between an information requesting side and an information providing side, the information requesting side comprising an information requesting application and the information providing side comprising an information providing application, wherein between said information requesting and information providing applications an agreement is created specifying what information is exchangeable therebetween, said agreement being represented by a form, the form being filled in by, and communicated between, the requesting and providing applications in both directions, being related to requesting data and/or providing data, and being implemented and communicated using a generic mark up language.

2. The arrangement according to claim 1, wherein the generic mark up language is XML.

3. The arrangement according to claim 1, wherein the form comprises an XML tree tagged with information about data to be “set”, retrieved, or data that is provided.

4. The arrangement according to claim 1, wherein the form comprises an XML tree with queries in the form of attributes and element data to be given values.

5. The arrangement according to claim 4, wherein the attributes comprise one or more of “from”, “get”, “null”, “error”, and “set”.

6. The arrangement according to claim 2, wherein the XML form is implemented and sent as an XML string.

7. The arrangement according to claim 3, wherein the tagged XML form is implemented as an XML DOM node object, and transforming/parsing means are provided in the applications for transforming XML objects to XML strings, using an XSL transformation style sheet (XSLT), and for parsing the XML strings to the XML DOM object respectively.

8. The arrangement according to claim 1, wherein server means are associated with the requesting and providing applications respectively.

9. The arrangement according to claim 8, wherein the providing application comprises means for converting a received XML form to a database call of SQL format, and the requested information is entered/filled in on the form on the providing side for retransmittal to the requesting application.

10. The arrangement according to claim 2, wherein the XML form is independent of the structural implementation of any information holding/providing database or similar.

11. The arrangement according to claim 10, wherein for the agreement a basic or general DTD is given, which is used when building a basic XML form to be filled in.

12. The arrangement according to claim 11, wherein validating means are provided for validation of a request.

13. The arrangement according to claim 12, wherein the validating means comprises end user controlled, user unique DTDs stored in information holding means, and a filled in XML form from a requesting application is validated against the appropriate end user unique DTD to establish whether the request is allowed or not.

14. The arrangement according to claim 13, wherein with the requesting and providing applications respective access means, plug-in server means are provided, which in communication with central protection server means form a personal protection profile network, said central server means comprising or communicating with personal protection profile holding means.

15. The arrangement according to claim 14, wherein the personal protection profile holding means holds end user unique personal protection profiles specifying which data within personal profiles are accessible to which applications, and said personal protection profiles comprise user unique DTDs that are end user controlled.

16. The arrangement according to claim 15, wherein an application and its associated access means communicate by means of XML objects in XML transport objects using RMI or CORBA.

17. The arrangement according to claim 16, wherein the access means associated with a requesting application finds a user unique DTD in the central server means using information about the basic general agreement provided from the requesting application, and in that the user unique DTD is validated against a request represented by a filled in XML form, to establish if a current request is allowed or not.

18. A data communication system providing communication between a number of applications comprising and/or communicating with service/information/content providers or holding means that hold end user personal profile data, wherein between each intercommunicating pair of applications an agreement is created to define what information is allowed to be transferred between the applications, bidirectionally or unidirectionally, information about agreements is stored in agreement information holding means, said agreements are represented as forms to be filled in and transferred between an information requesting application and an information providing application, and a generic mark up language is used for implementation and communication of said forms.

19. The data communication system according to claim 18, the generic mark up language is XML.

20. The system according to claim 19, wherein the forms comprise XML trees tagged with information about data to the “set” or “get” by the requesting application or with data to be provided.

21. The system according to claim 18, wherein agreements are held by the respective applications between which an agreement has been established or by means associated therewith, and in that said agreements comprise DTDs.

22. The system according to claim 18, wherein the system comprises a personal profile protection network, comprising access means associated with each respective application and central protection server means, comprising or communicating with information holding means, whereby said information holding means comprise said agreement holding means.

23. The system at least according to claim 19, wherein attributes and elements are used in the XML tree form, which attributes and elements are given the appropriate values/data, which constitutes filling in the form.

24. The system according to claim 19, wherein the XML form is implemented as an XML DOM node tree object, and communicated between applications as an XML string, transforming/parsing means being provided in the applications for transforming the XML DOM node tree object to an XML string for parsing the XML string to the XML DOM node tree object.

25. The system according to claim 22, wherein validating means comprising end user controlled, user unique DTDs or personal protection profiles stored in the information holding means, an XML form from a requesting application being validated against the appropriate user unique DTL to establish whether the request is allowed or not.

26. A method for exchanging information between an information requesting application and an information providing application having established an agreement to specify which information is allowed to be transferred between the information requesting and information providing applications, the method comprising the steps of:
creating, using a generic mark up language, a form with elements and attributes wherein the attributes are used to indicate element(s) to be filled with data, according to the agreement;
transferring the filled in form tagged with information relating to requested data from the requesting application to the providing application;
receiving the form at the receiving application;
converting the request form to a database call;
accessing information holding means using a database call; and
if the request relates to retrieving data, filling in the form using data retrieved from an information holding site;
returning the requested information to the requesting application, otherwise;
setting data according to the tagged form in the information holding means according to the request.

27. The method according to claim 26, wherein the generic mark up language is XML, and in that the form comprises an XML tree in DOM object form or in string form with attributes used to indicate elements to be filled with data according to established agreements.

28. The method according to claim 27, wherein the agreement comprises a DTD.

29. The method according to claim 27, further comprising the step of:
communicating the XML form tagged with information as an XML string.

30. The method according to claim 27, further comprising the step of, if the XML form is implemented as an XML object, converting the XML object to an XML string in the requesting/providing applications respectively for transportation between the applications.

31. The method according to claim 29, further comprising the step of:
validating the XML tree against a user unique DTD stored in personal protection profile holding means; and
providing information as allowed according to the outcome of the validation.
